(19) United States
(12) Patent Application Publication
(10) Pub. No.: US 2025/0220620 A1
(43) Pub. Date: Jul. 3, 2025

(54) METHODS, DEVICES, AND COMPUTER READABLE MEDIUM FOR COMMUNICATION

(71) Applicant: NEC CORPORATION, Tokyo (JP)

(72) Inventors: Gang WANG, Beijing (CN); Peng GUAN, Beijing (CN)

(73) Assignee: NEC CORPORATION, Tokyo (JP)

(21) Appl. No.: 18/848,674

(22) PCT Filed: Mar. 28, 2022
(86) PCT No.: PCT/CN2022/083489

§ 371 Date: Sep. 19, 2024

(51) Int. Cl. H04W 64/00; H04B 17/26; H04W 24/02

(52) U.S. Cl. CPC H04W 64/00; H04B 17/26; H04W 24/02

(57) ABSTRACT

Embodiments of the present disclosure relate to methods, devices, and computer readable medium for communication. According to embodiments of the present disclosure, an artificial intelligence/machine learning (AI/ML) based positioning model is deployed at a terminal device or a network device. If the AI/ML based positioning model is triggered, location related measurement information of the terminal device is determined based on the AI/ML based positioning model. A core network device estimates a position of the terminal device based on the reported location related measurement information. In this way, the terminal device can be positioned more accurately.

### TECHNICAL FIELD

Embodiments of the present disclosure generally relate to the field of telecommunication, and in particular, to methods, devices, and computer readable medium for communication.

### BACKGROUND

Several technologies have been proposed to improve communication performances. For example, communication devices may employ an artificial intelligent/machine learning (AI/ML) model to improve communication qualities. The AI/ML model can be applied to different scenarios to achieve better performances. A recent work item has been conducted in the third generation partner project (3GPP) for positioning support in new radio (NR) system. A new reference signal for positioning has been introduced in downlink. For example, the terminal devices may measure the reference signal time difference (RSTD) between positioning reference signals (PRSs) from different transmission points in order to perform positioning. Alternatively or in addition, the terminal devices can measure a receiving-transmitting (Rx-Tx) time difference where the time difference is between two PRSs.

### SUMMARY

In general, example embodiments of the present disclosure provide a solution for communication.

In a first aspect, there is provided a method for communication. The method comprises receiving, at a terminal device, a configuration of an artificial intelligence/machine learning (AI/ML) based positioning model from a network device and an indication of starting the AI/ML based positioning model, the configuration of the AI/ML based positioning model comprising a set of parameters for the AI/ML based positioning model; in accordance with a determination that the AI/ML based positioning model is triggered, determining location related measurement information of the terminal device based on the AI/ML based positioning model; and transmitting the location related measurement information.

In a second aspect, there is provided a method for communication. The method comprises transmitting, at a network device, a configuration of an artificial intelligence/machine learning (AI/ML) based positioning model and an indication of start the AI/ML based positioning model to a terminal device, the configuration of the AI/ML based positioning model comprising a set of parameters for the AI/ML based positioning model.

In a third aspect, there is provided a method for communication. The method comprises transmitting, at a network device and to a terminal device, an indication of starting an artificial intelligence/machine learning (AI/ML) based positioning model; in accordance with a determination that the AI/ML based positioning model is triggered, determining location related measurement information of the terminal device based on the AI/ML based positioning model; and transmitting the location related measurement information.

In a fourth aspect, there is provided a method for communication. The method comprises receiving, at a terminal device and from a network device, an indication of starting an artificial intelligence/machine learning (AI/ML) based positioning model.

In a fifth aspect, there is provided a terminal device. The terminal device comprises a processing unit; and a memory coupled to the processing unit and storing instructions thereon, the instructions, when executed by the processing unit, causing the terminal device to perform the method according to the first or fourth aspect.

In a sixth aspect, there is provided a network device. The network device comprises a processing unit; and a memory coupled to the processing unit and storing instructions thereon, the instructions, when executed by the processing unit, causing the network device to perform the method according to the second or third aspect.

In a seventh aspect, there is provided a computer readable medium having instructions stored thereon, the instructions, when executed on at least one processor, causing the at least one processor to carry out the method according to any one of the first, second, third or fourth aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 illustrates a signaling flow for communications according to some embodiments of the present disclosure;

FIG. 3 illustrates a signaling flow for communications according to some embodiments of the present disclosure;

FIG. 4 illustrates a signaling flow for communications according to some embodiments of the present disclosure;

FIG. 5 illustrates a signaling flow for communications according to some embodiments of the present disclosure;

FIG. 6 illustrates a schematic diagram of positioning reference signal (PRS) resources;

FIG. 7 is a flowchart of an example method in accordance with an embodiment of the present disclosure;

FIG. 8 is a flowchart of an example method in accordance with an embodiment of the present disclosure;

FIG. 9 is a flowchart of an example method in accordance with an embodiment of the present disclosure;

FIG. 10 is a flowchart of an example method in accordance with an embodiment of the present disclosure; and

FIG. 11 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device. In the following description, the terms “terminal device”, “communication device”, “terminal”, “user equipment” and “UE” may be used interchangeably.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHZ-7125 MHz), FR2 (24.2 5GHz to 71 GHz), frequency band larger than 100 GHz as well as Terahertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As mentioned above, it was conducted in 3GPP for positioning support in NR. Supporting various positioning methods to provide reliable and accurate UE location has always been one of the key features of 3GPP standard. Further, the AI/ML model can be applied to achieve better performances. Therefore, it is worthy applying the AI/ML model into positioning of terminal devices.

According to embodiments of the present disclosure, an artificial intelligence/machine learning (AI/ML) based positioning model is implemented at a terminal device or a network device. If the AI/ML based positioning model is triggered, location related measurement information of the terminal device is determined based on the AI/ML based positioning model. A core network device estimates a position of the terminal device based on the location related measurement information. In this way, the terminal device can be positioned more accurately.

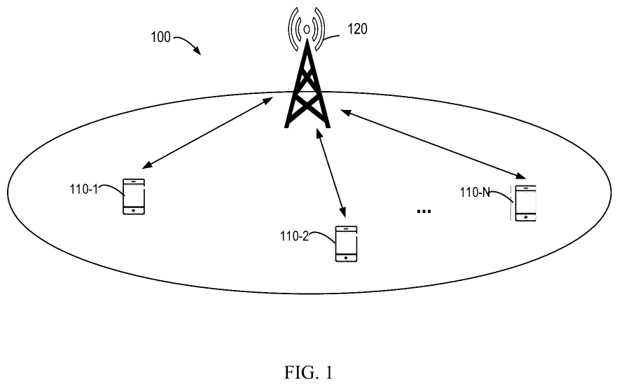

FIG. 1 illustrates a schematic diagram of a communication system in which embodiments of the present disclosure can be implemented. The communication system 100, which is a part of a communication network, comprises a terminal device 110-1, a terminal device 110-2, . . . , a terminal device 110-N, which can be collectively referred to as “terminal device(s) 110.” The number N can be any suitable integer number.

The communication system 100 further comprises a network device 120. In the communication system 100, the network device 120 and the terminal devices 110 can communicate data and control information to each other. The numbers of terminal devices shown in FIG. 1 are given for the purpose of illustration without suggesting any limitations. The communication system also comprises a core network device 130. For example, the core network device 130 may be a location management function (LMF) entity.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHz, an extending NR operation up to 71 GHz, narrow band-Internet of Thing (NB-IoT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

The term “slot” used herein refers to a dynamic scheduling unit. One slot comprises a predetermined number of symbols. The term “downlink (DL) sub-slot” may refer to a virtual sub-slot constructed based on uplink (UL) sub-slot. The DL sub-slot may comprise fewer symbols than one DL slot. The slot used herein may refer to a normal slot which comprises a predetermined number of symbols and also refer to a sub-slot which comprises fewer symbols than the predetermined number of symbols.

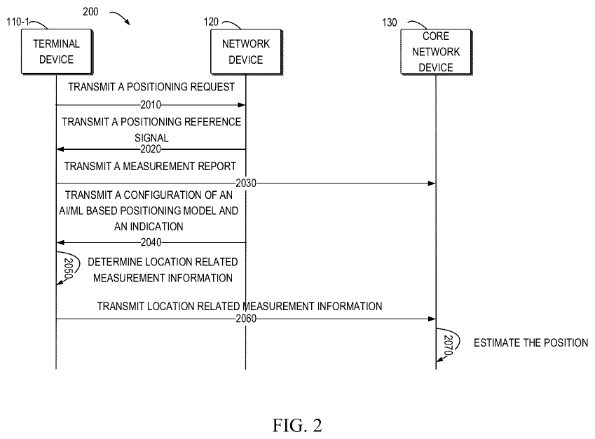

Embodiments of the present disclosure where the AI/ML based processing model is implemented at the terminal device will be described in detail below. Reference is first made to FIG. 2, which shows a signaling chart illustrating process 200 between the terminal device and the network device according to some example embodiments of the present disclosure. Only for the purpose of discussion, the process 200 will be described with reference to FIG. 1. The process 200 may involve the terminal device 110-1and the network device 120 in FIG. 1.

The network device 120 may transmit a configuration of positioning reference signal (PRS) to the terminal device 110-1. The configuration may indicate a set of occasions on which a PRS can be transmitted. The term “occasion” may occupy a time domain and frequency domain resource. The terminal device 110-1 may transmit 2010 a positioning request for downlink positioning to the network device 120.

The terminal device 110-1 may monitor the PRS on the occasions based on the configuration. The network device 120 may transmit 2020 a set of PRSs to the terminal device 110-1. A neighbor network device (not shown) may also transmit a set of PRSs to the terminal device 110-1.

The terminal device 110-1 may perform a measurement on the set of PRSs. For example, the measurement may be a reference signal time difference, RSTD, measurement. Alternatively or in addition, the measurement may also be a reference signal received power (RSRP) measurement. In some other embodiments, the measurement may be a receiving-transmitting (Rx-Tx) time difference measurement.

The terminal device 110-1 may transmit 2030 a measurement report to the core network device 130. For example, the measurement report may indicate the measured RSTD. Alternatively or in addition, the measurement report may indicate the measured RSRP. In some other embodiments, the measurement report may indicate the measured Rx-Tx time difference.

In some embodiments, the terminal device 110-1 may determine whether a condition for triggering the AI/ML based positioning model is fulfilled. Alternatively, the network device 120 may determine whether a condition for triggering the AI/ML based positioning model is fulfilled. In some embodiments, the condition for triggering the AI/ML based positioning model may be that the line of sight (LOS) path does not exist due to the movement of the terminal device 110-1. Alternatively, the condition for triggering the AI/ML based positioning model may be that the LOS path does not exist due to changes of propagation environment. In some other embodiments, the condition for triggering the AI/ML based positioning model may be an unexpected synchronization error between the terminal device 110-1 and the network device 120 or between network devices. In another embodiment, the condition for triggering the AI/ML based positioning model may be that the reference position is inaccurate due to the movement of the network device 120. In some embodiments, the condition for triggering the AI/ML based positioning model may be a poor DL hearability from the neighbor cell to the terminal device 110-1. For example, if a link quality between a neighbor cell and the terminal device 110-1 is below a threshold, the AI/ML based positioning model may be triggered. Alternatively or in addition, the condition for triggering the AI/ML based positioning model may be reduction of overhead of reference signal. It should be noted that the condition for triggering the AI/ML based positioning model may comprise any other conditions which are not described.

In some embodiments, if the AI/ML based positioning model is triggered by the network device 120, the network device 120 may inform the terminal device 110-1 to start the AI/ML based positioning model. For example, the network device 120 may transmit an indication for starting the AI/ML based positioning model to the terminal device 110-1. In some embodiments, this indication can be transmitted in downlink control information. Alternatively, this indication can be transmitted in a medium access control (MAC) control element (CE). In example embodiments, the terminal device 110-1 may feedback to the network device 120 that the AI based positioning is not performed for some reasons, for example, UE power saving.

Alternatively, if the AI/ML based positioning model is triggered by the terminal device 110-1, the terminal device 110-1 may inform the network device 120 to mute the PRS resources during the AI/ML based positioning. Optionally, the network device 120 can inform the terminal device 110-1that AI based positioning is not performed for some reasons.

In some embodiments, if the AI/ML based positioning model is triggered, the network device 120 may cause the transmission of the PRS to be skipped. In other words, the network device 120 may mute resources for the PRS transmission. For example, as shown in FIG. 6, the PRSs can be transmitted on resources 610-1, 610-2, 610-3, 610-4, 610-5, 610-6 and 610-7. The AI/ML based positioning model may be triggered at the time instance 620. The AI/ML based positioning model may be running within the duration 630. In this case, the resources 610-3, 610-4 and 610-5 which are within the duration 630 can be muted. In other words, the network device 120 may not transmit PRSs within the duration 630. After the AI/ML based positioning model stops, the network device 120 may start to transmit PRSs.

The network device 120 may transmit 2040 a configuration of an AI/ML based positioning model. In addition, the network device 120 may transmit an indication of start the AI/ML based positioning model to the terminal device 110-1. For example, the configuration of the AI/ML based positioning model may be transmitted via RRC signaling. In some embodiments, the configuration of the AI/ML based positioning model comprises a set of parameters for the AI/ML based positioning model. In some embodiments, the set of parameter may comprise an offset between a slot for an indication of triggering the AI/ML based positioning model and a start slot for the AI/ML based positioning model.

Alternatively or in addition, the set of parameter may comprise a duration parameter for the AI/ML based positioning model. In some embodiments, the duration parameter may comprise a bitmap parameter set to a predetermined value. For example, the bitmap b⁰ and b¹ can be set to 0. Alternatively, the duration parameter may comprise an on-duration timer of the AI/ML based positioning model. For example, the AI/ML based positioning model may be used during running time of the on-duration timer. In some other embodiments, the duration parameter may comprise a parameter for disabling a higher layer parameter. For example, the parameter “NR-DL-PRS-PositioningFrequencyLayer” may be disabled. Alternatively, the parameter “NR-DL-PRS-ResourceSet” may be disabled.

If the AI/ML based positioning model is triggered, the terminal device 110-1 may determine 2050 location related measurement information of the terminal device 110-1 based on the AI/ML based positioning model. In some embodiments, the terminal device 110-1 may start the AI/ML based location estimation based on a historical location of the terminal device 110-1. Alternatively or in addition, the AI/ML based location estimation may be started based on a moving speed of the terminal device 110-1 and/or a moving direction of the terminal device 110-1 or the user preference profile, for example, user habits. It should be noted that the terminal device 110-1 may start the location estimation of the terminal device 110-1 using the positioning mode based on any proper factors.

In some embodiments, an input of the AI/ML based positioning model may comprise a set of previous RSTD measurements. Alternatively or in addition, the input of the AI/ML based positioning model may comprise a set of historical RSRP measurements. In some other embodiments, the input of the AI/ML based positioning model may comprise a set of historical round trip time (RTT) measurements. The above historical measurements may be obtained based on previous PRSs. The input of the AI/ML based positioning model may also comprise a set of historical location coordinates of the terminal device 110-1. For example, the location coordinates may be obtained from a global positioning system.

In some embodiments, an output of the AI/ML based positioning model may comprise relative location information of the terminal device 110-1 with respect to a location determined based on the last reference signal. For example, this reference signal may be a PRS or a sounding reference signal. In some embodiments, the relative location information of the terminal device 110-1 may comprise a location coordinate of the terminal device 110-1 with respect to the last position based on the last reference signal. Alternatively, the relative location information of the terminal device 110-1 may comprise a RSTD with respect to the last reference signal. In other embodiments, the relative location of the terminal device 110-1 may comprise a RSRP with respect to the last reference signal. The relative location of the terminal device 110-1 may comprise a RTT with respect to the last reference signal.

Alternatively or in addition, the output of the AI/ML based positioning model may comprise absolute location information of the terminal device 110-1. In some embodiments, the absolute location information of the terminal device 110-1 may comprise a location coordinate of the terminal device 110-1. Alternatively, the absolute location of the terminal device 110-1 may comprise a RSTD. In other embodiments, the absolute location of the terminal device 110-1 may comprise a RSRP. The absolute location of the terminal device 110-1 may comprise a RTT.

The terminal device 110-1 may transmit 2060 the location related measurement information to the core network device 130. In some embodiments, the terminal device 110-1 may transmit the location related measurement information on a physical uplink shared channel (PUSCH) which is scheduled by downlink control information. Alternatively, the location related measurement information may be transmitted on a configured grant (CG) PUSCH. The core network device130 may estimate 2070 the position of the terminal device 110-1 based on the location related measurement information.

In some embodiments, if the output of the AI/ML based positioning model is the absolute location information of the terminal device 110-1, the location related measurement information may comprise the absolute location of the terminal device 110-1. Alternatively, if the output of the AI/ML based positioning model is the relative location information of the terminal device 110-1, the location related measurement information may comprise a combination of the relative location measurement and the location information determined based on the last reference signal.

In some embodiments, for observed time difference of arrival (OTDOA), the location related measurement information may comprise the RSTD which is a combination of the last measured RSTD before AI based positioning and Δ_{RSTD}, where Δ_{RSTD} is timing difference transformed from the output of the AI/ML based model.

Alternatively or in addition, for DL angle of departure (DL-AOD), the location related measurement information may comprise the RSRP which is a combination of the last measured RSRP before AI based positioning and Δ_{RSRP}, where Δ_{RSRP} is the RSRP value transformed from the output of the AI/ML based model. In some other embodiments, for UE Rx-TX time difference, the location related measurement information may comprise the RTT which is a combination of the last measured RTT before AI based positioning and Δ_{RTT}, where Δ_{RTT} is timing difference transformed from the output of the AI/ML based model.

According to embodiments described with reference to FIG. 2, the AI/ML based positioning model for DL measurement can be implemented at the terminal device. In this way, the position of the terminal device can be estimated more accurately. Moreover, since the terminal device does not need to monitor PRSs during the positioning, the power can be saved.

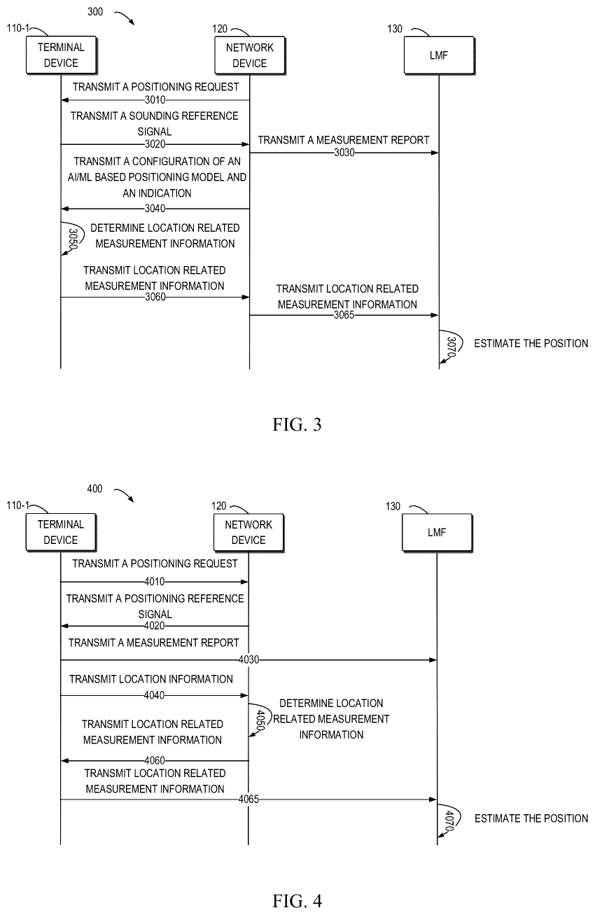

Embodiments of the present disclosure where the AI/ML based processing model is implemented at the terminal device will be described in detail below. Reference is first made to FIG. 3, which shows a signaling chart illustrating process 300 between the terminal device and the network device according to some example embodiments of the present disclosure. Only for the purpose of discussion, the process 300 will be described with reference to FIG. 1. The process 300 may involve the terminal device 110-1and the network device 120 in FIG. 1.

The network device 120 may transmit a configuration of sounding reference signal (SRS) to the terminal device 110-1. In some embodiments, the configuration of SRS can be received via RRC signaling. In some embodiments, the configuration of SRS can comprise a number of physical resource blocks including transmission periodicity which are allocated for the SRS. Alternatively or in addition, the configuration of SRS can comprise a bandwidth parameter of SRS. In some embodiments, the configuration of SRS may indicate one or more SRS resources. Alternatively or in addition, the configuration of SRS may indicate one or more SRS resource sets. The network device 120 may transmit 3010 a positioning request for uplink positioning to the terminal device 110-1.

The terminal device 110-1 may transmit 3020 a set of SRSs to the network device 120 based on the configuration of SRS. The network device 120 may perform a measurement on the set of SRSs. For example, the measurement may be an UL RSTD, measurement. Alternatively or in addition, the measurement may also be an UL RSRP measurement. In some other embodiments, the measurement may be a Rx-Tx time difference measurement. The measurement may also be an UL angle of arrival (AOA).

The network device 120 may transmit 3030 a measurement report to the core network device 130. For example, the measurement report may indicate the measured UL RSTD. Alternatively or in addition, the measurement report may indicate the measured UL RSRP. In some other embodiments, the measurement report may indicate the measured UL Rx-Tx time difference. In some embodiments, the measurement report may indicate the measured UL AOA.

In some embodiments, the terminal device 110-1 may determine whether a condition for triggering the AI/ML based positioning model is fulfilled. Alternatively, the network device 120 may determine whether a condition for triggering the AI/ML based positioning model is fulfilled. In some embodiments, the condition for triggering the AI/ML based positioning model may be that the line of sight (LOS) path does not exist due to the movement of the terminal device 110-1. Alternatively, the condition for triggering the AI/ML based positioning model may be that the LOS path does not exist due to changes of propagation environment. In some other embodiments, the condition for triggering the AI/ML based positioning model may be an unexpected synchronization error between the terminal device 110-1 and the network device 120 or between network devices. In another embodiment, the condition for triggering the AI/ML based positioning model may be that the reference position is inaccurate due to the movement of the network device 120. In some embodiments, the condition for triggering the AI/ML based positioning model may be a poor DL hearability from the neighbor cell to the terminal device 110-1. For example, if a link quality between a neighbor cell and the terminal device 110-1 is below a threshold, the AI/ML based positioning model may be triggered. Alternatively or in addition, the condition for triggering the AI/ML based positioning model may be reduction of overhead of reference signal. It should be noted that the condition for triggering the AI/ML based positioning model may comprise any other conditions which are not described.

In some embodiments, if the AI/ML based positioning model is triggered by the network device 120, the network device 120 may inform the terminal device 110-1 to start the AI/ML based positioning model. For example, the network device 120 may transmit an indication for starting the AI/ML based positioning model to the terminal device 110-1. In some embodiments, this indication can be transmitted in downlink control information. Alternatively, this indication can be transmitted in a medium access control (MAC) control element (CE). In example embodiments, the terminal device 110-1 may feedback to the network device 120 that the AI based positioning is not performed for some reasons, for example, UE power saving.

Alternatively, if the AI/ML based positioning model is triggered by the terminal device 110-1, the terminal device 110-1 may inform the network device 120 to mute the PRS resources during the AI/ML based positioning. Optionally, the network device 120 can inform the terminal device 110-1that AI based positioning is not performed for some reasons.

In some embodiments, if the AI/ML based positioning model is triggered, the network device 120 may cause the transmission of the PRS to be skipped. In other words, the network device 120 may mute resources for the PRS transmission. For example, as shown in FIG. 6, the PRSs can be transmitted on resources 610-1, 610-2, 610-3, 610-4, 610-5, 610-6 and 610-7. The AI/ML based positioning model may be triggered at the time instance 620. The AI/ML based positioning model may be running within the duration 630. In this case, the resources 610-3, 610-4 and 610-5 which are within the duration 630 can be muted. In other words, the network device 120 may not transmit PRSs within the duration 630. After the AI/ML based positioning model stops, the network device 120 may start to transmit PRSs.

Alternatively, if the AI/ML based positioning model is triggered, the terminal device 110-1 may cause the transmission of the SRS to be skipped. In other words, the terminal device 110-1 may mute resources for the SRS transmission.

The network device 120 may transmit 3040 a configuration of an AI/ML based positioning model to the terminal device 110-1. In addition, the network device 120 may transmit an indication of start the AI/ML based positioning model to the terminal device 110-1. For example, the configuration of the AI/ML based positioning model may be transmitted via RRC signaling. In some embodiments, the configuration of the AI/ML based positioning model comprises a set of parameters for the AI/ML based positioning model. In some embodiments, the set of parameter may comprise an offset between a slot for an indication of triggering the AI/ML based positioning model and a start slot for the AI/ML based positioning model.

Alternatively or in addition, the set of parameter may comprise a duration parameter for the AI/ML based positioning model. In some embodiments, the duration parameter may comprise a bitmap parameter set to a predetermined value. For example, the bitmap b⁰ and b¹ can be set to 0. Alternatively, the duration parameter may comprise an on-duration timer of the AI/ML based positioning model. For example, the AI/ML based positioning model may be used during running time of the on-duration timer. In some other embodiments, the duration parameter may comprise a parameter for disabling a higher layer parameter. For example, the parameter “NR-DL-PRS-PositioningFrequencyLayer” may be disabled. Alternatively, the parameter “NR-DL-PRS-ResourceSet” may be disabled.

If the AI/ML based positioning model is triggered, the terminal device 110-1 may determine 3050 location related measurement information of the terminal device 110-1 based on the AI/ML based positioning model. In some embodiments, the terminal device 110-1 may start the AI/ML based location estimation based on a historical location of the terminal device 110-1. Alternatively or in addition, the AI/ML based location estimation may be started based on a moving speed of the terminal device 110-1 and/or a moving direction of the terminal device 110-1 or the user preference profile, for example, user habits. It should be noted that the terminal device 110-1 may start the location estimation of the terminal device 110-1 using the positioning mode based on any proper factors.

In some embodiments, an input of the AI/ML based positioning model may comprise a set of previous RSTD measurements. Alternatively or in addition, the input of the AI/ML based positioning model may comprise a set of historical RSRP measurements. In some other embodiments, the input of the AI/ML based positioning model may comprise a set of historical round trip time (RTT) measurements. The above historical measurements may be obtained based on previous PRSs. The input of the AI/ML based positioning model may also comprise a set of historical location coordinates of the terminal device 110-1. For example, the location coordinates may be obtained from a global positioning system.

In some embodiments, an output of the AI/ML based positioning model may comprise relative location information of the terminal device 110-1 with respect to a location determined based on the last reference signal. For example, this reference signal may be a PRS or a sounding reference signal. In some embodiments, the relative location information of the terminal device 110-1 may comprise a location coordinate of the terminal device 110-1 with respect to the last position based on the last reference signal. Alternatively, the relative location information of the terminal device 110-1 may comprise a RSTD with respect to the last reference signal. In other embodiments, the relative location of the terminal device 110-1 may comprise a RSRP with respect to the last reference signal. The relative location of the terminal device 110-1 may comprise a RTT with respect to the last reference signal.

Alternatively or in addition, the output of the AI/ML based positioning model may comprise absolute location information of the terminal device 110-1. In some embodiments, the absolute location information of the terminal device 110-1 may comprise a location coordinate of the terminal device 110-1. Alternatively, the absolute location of the terminal device 110-1 may comprise a RSTD. In other embodiments, the absolute location of the terminal device 110-1 may comprise a RSRP. The absolute location of the terminal device 110-1 may comprise a RTT.

The terminal device 110-1 may transmit 3060 the location related measurement information to the network device 120. In some embodiments, the terminal device 110-1 may transmit the location related measurement information on a physical uplink shared channel (PUSCH) which is scheduled by downlink control information. Alternatively, the location related measurement information may be transmitted on a CG PUSCH.

In some embodiments, the location related measurement information may comprise the original output of the AI/ML based positioning model. For example, if the output of the AI/ML based positioning model is the absolute location of the terminal device 110-1, the location related measurement information may comprise the absolute location of the terminal device 110-1.

In some other embodiments, the location related measurement information may comprise a relative location of the terminal device with respect to a location determined based on a last reference signal. Alternatively, the location related measurement information may comprise an as-the-crow-flies distance with respect to a last measurement slot of the last reference signal. In some embodiments, the location related measurement information may comprise an azimuth angle with respect to the last measurement slot. In another embodiment, the location related measurement information may comprise an elevation angle with respect to the last measurement slot.

Alternatively, the location related measurement information may comprise the UL ROTA. In some embodiments, the location related measurement information may comprise the UL AOA. In other embodiments, the location related measurement information may comprise the UL RSRP. The location related measurement information may also comprise gNB Rx-Tx time difference. The UL ROTA, UL AOA, UL RSRP, gNB Rx-Tx time difference may be transformed according to the location of the terminal device 110-1 predicted based on the AI/ML positioning model.

The network device 120 may transmit 3065 the location related measurement information to the core network device 130. The core network device130 may estimate 3070 the position of the terminal device 110-1 based on the location related measurement information.

In some embodiments, the network device 120 may inform the absolution location of terminal device 110-1 to the core network device 130. For example, one or more of the followings can be transmitted to the core network device 130: the location coordinate, the RTOA, AOA, RSRP or RTT of the terminal device 110-1.

Alternatively, if the network device 120 receives the relative location of terminal device 110-1, the network device 120 may combine the relation location of terminal device 110-1 and the location determined based on the last reference signal. For example, for observed time difference of arrival (OTDOA), the location related measurement information may comprise the RSTD which is a combination of the last measured RSTD before AI based positioning and Δ_{RSTD}, where Δ_{RSTD} is timing difference transformed from the output of the AI/ML based model. Alternatively or in addition, for DL angle of departure (DL-AOD), the location related measurement information may comprise the RSRP which is a combination of the last measured RSRP before AI based positioning and Δ_{RSRP}, where Δ_{RSRP} is the RSRP value transformed from the output of the AI/ML based model. In some other embodiments, for UE Rx-TX time difference, the location related measurement information may comprise the RTT which is a combination of the last measured RTT before AI based positioning and Δ_{RTT}, where Δ_{RTT} is timing difference transformed from the output of the AI/ML based model.

According to embodiments described with reference to FIG. 3, the AI/ML based positioning model for UL measurement can be implemented at the terminal device. In this way, the position of the terminal device can be estimated more accurately. Moreover, since the terminal device does not need to monitor PRSs during the positioning, the power can be saved.

Embodiments of the present disclosure where the AI/ML based processing model is implemented at the network device will be described in detail below. Reference is first made to FIG. 4, which shows a signaling chart illustrating process 400 between the terminal device and the network device according to some example embodiments of the present disclosure. Only for the purpose of discussion, the process 400 will be described with reference to FIG. 1. The process 400 may involve the terminal device 110-1and the network device 120 in FIG. 1.

The network device 120 may transmit a configuration of PRS to the terminal device 110-1. The configuration may indicate a set of occasions on which a PRS can be transmitted. The term “occasion” may occupy a time domain and frequency domain resource. The terminal device 110-1 may transmit 4010 a positioning request for downlink positioning to the network device 120.

The terminal device 110-1 may monitor the PRS on the occasions based on the configuration. The network device 120 may transmit 4020 a set of PRSs to the terminal device 110-1. A neighbor network device (not shown) may also transmit a set of PRSs to the terminal device 110-1.

The terminal device 110-1 may perform a measurement on the set of PRSs. For example, the measurement may be a reference signal time difference, RSTD, measurement. Alternatively or in addition, the measurement may also be a RSRP measurement. In some other embodiments, the measurement may be a Rx-Tx time difference measurement.

The terminal device 110-1 may transmit 4030 a measurement report to the core network device 130. For example, the measurement report may indicate the measured RSTD. Alternatively or in addition, the measurement report may indicate the measured RSRP. In some other embodiments, the measurement report may indicate the measured Rx-Tx time difference.

In some embodiments, the terminal device 110-1 may determine whether a condition for triggering the AI/ML based positioning model is fulfilled. Alternatively, the network device 120 may determine whether a condition for triggering the AI/ML based positioning model is fulfilled. In some embodiments, the condition for triggering the AI/ML based positioning model may be that the line of sight (LOS) path does not exist due to the movement of the terminal device 110-1. Alternatively, the condition for triggering the AI/ML based positioning model may be that the LOS path does not exist due to changes of propagation environment. In some other embodiments, the condition for triggering the AI/ML based positioning model may be an unexpected synchronization error between the terminal device 110-1 and the network device 120 or between network devices. In another embodiment, the condition for triggering the AI/ML based positioning model may be that the reference position is inaccurate due to the movement of the network device 120. In some embodiments, the condition for triggering the AI/ML based positioning model may be a poor DL hearability from the neighbor cell to the terminal device 110-1. For example, if a link quality between a neighbor cell and the terminal device 110-1 is below a threshold, the AI/ML based positioning model may be triggered. Alternatively or in addition, the condition for triggering the AI/ML based positioning model may be reduction of overhead of reference signal. It should be noted that the condition for triggering the AI/ML based positioning model may comprise any other conditions which are not described.

In some embodiments, if the AI/ML based positioning model is triggered by the network device 120, the network device 120 may inform the terminal device 110-1 to start the AI/ML based measurement. In some embodiments, this indication can be transmitted in downlink control information. Alternatively, this indication can be transmitted in a medium access control (MAC) control element (CE). In example embodiments, the terminal device 110-1 may feedback to the network device 120 that the AI based positioning is not performed for some reasons, for example, UE power saving.

Alternatively, if the AI/ML based positioning model is triggered by the terminal device 110-1, the terminal device 110-1 may inform the network device 120 to mute the PRS resources during the AI/ML based positioning. Optionally, the network device 120 can inform the terminal device 110-1that AI based positioning is not performed for some reasons.

In some embodiments, if the AI/ML based positioning model is triggered, the network device 120 may cause the transmission of the PRS to be skipped. In other words, the network device 120 may mute resources for the PRS transmission. For example, as shown in FIG. 6, the PRSs can be transmitted on resources 610-1, 610-2, 610-3, 610-4, 610-5, 610-6 and 610-7. The AI/ML based positioning model may be triggered at the time instance 620. The AI/ML based positioning model may be running within the duration 630. In this case, the resources 610-3, 610-4 and 610-5 which are within the duration 630 can be muted. In other words, the network device 120 may not transmit PRSs within the duration 630. After the AI/ML based positioning model stops, the network device 120 may start to transmit PRSs.

In some embodiments, after receiving an indication of starting the AI/ML based positioning model, the terminal device 110-1 may not monitor the PRS on the occasions based on the configuration. The terminal device 110-1 may also transmit 4040 location related information to the network device 120. For example, the location related information may indicate a moving speed of the terminal device 110-1. Alternatively or in addition, the location related information may indicate a moving direction of the terminal device 110-1. The location related information may be transmitted on PUSCH.

If the AI/ML based positioning model is triggered, the network device 120 may determine 4050 location related measurement information of the terminal device 110-1 based on the AI/ML based positioning model. In some embodiments, the network device 120 may start the AI/ML based location estimation based on a historical location of the terminal device 110-1. Alternatively or in addition, the AI/ML based location estimation may be started based on a moving speed of the terminal device 110-1 and/or a moving direction of the terminal device 110-1 or the user preference profile, for example, user habits. It should be noted that the network device 120 may start the location estimation of the terminal device 110-1 using the positioning mode based on any proper factors.

In some embodiments, an input of the AI/ML based positioning model may comprise a set of previous RSTD measurements. Alternatively or in addition, the input of the AI/ML based positioning model may comprise a set of historical RSRP measurements. In some other embodiments, the input of the AI/ML based positioning model may comprise a set of RTT measurements. The input of the AI/ML based positioning model may also comprise a set of historical location coordinates of the terminal device 110-1. For example, the location coordinates may be obtained from a global positioning system.

In some embodiments, an output of the AI/ML based positioning model may comprise relative location information of the terminal device 110-1 with respect to a location determined based on the last reference signal. For example, this reference signal may be a PRS or a sounding reference signal. In some embodiments, the relative location information of the terminal device 110-1 may comprise a location coordinate of the terminal device 110-1 with respect to the last position based on the last reference signal. Alternatively, the relative location of the terminal device 110-1 may comprise a RSTD with respect to the last reference signal. In other embodiments, the relative location of the terminal device 110-1 may comprise a RSRP with respect to the last reference signal. The relative location of the terminal device 110-1 may comprise a RTT with respect to the last reference signal.

Alternatively or in addition, the output of the AI/ML based positioning model may comprise absolute location information of the terminal device 110-1. In some embodiments, the absolute location information of the terminal device 110-1 may comprise a location coordinate of the terminal device 110-1. Alternatively, the absolute location of the terminal device 110-1 may comprise a RSTD. In other embodiments, the absolute location of the terminal device 110-1 may comprise a RSRP. The absolute location of the terminal device 110-1 may comprise a RTT.

The network device 120 may transmit 4060 the location related measurement information to the terminal device 110-1. In some embodiments, the network device 120 may transmit the location related measurement information on PDSCH.

In some embodiments, the location related measurement information may comprise the original output of the AI/ML based positioning model. For example, if the output of the AI/ML based positioning model is the absolute location of the terminal device 110-1, the location related measurement information may comprise the absolute location of the terminal device 110-1.

In some other embodiments, the location related measurement information may comprise relative location information of the terminal device with respect to a location determined based on a last reference signal. Alternatively, the location related measurement information may comprise an as-the-crow-flies distance with respect to a last measurement slot of the last reference signal. In some embodiments, the location related measurement information may comprise an azimuth angle with respect to the last measurement slot. In another embodiment, the location related measurement information may comprise an elevation angle with respect to the last measurement slot.

Alternatively, the location related measurement information may comprise the DL ROTA. In some embodiments, the location related measurement information may comprise the DL AOA. In other embodiments, the location related measurement information may comprise the DL RSRP. The location related measurement information may also comprise a Rx-Tx time difference. The DL ROTA, DL AOA, DL RSRP, Rx-Tx time difference may be transformed according to the location of the terminal device 110-1 predicted based on the AI/ML positioning model.

The terminal device 110-1 may transmit 4065 the location related measurement information to the core network device 130. In some embodiments, the terminal device 110-1 may transmit the location related measurement information on a PUSCH which is scheduled by downlink control information. Alternatively, the location related measurement information may be transmitted on a CG PUSCH. The core network device 130 may estimate 4070 the position of the terminal device 110-1 based on the location related measurement information.

In some embodiments, the terminal device 110-1 may inform the absolution location of terminal device 110-1 to the core network device 130. For example, one or more of the followings can be transmitted to the core network device 130: the location coordinate, the RTOA, AOA, RSRP or RTT of the terminal device 110-1.

Alternatively, if the terminal device 110-1 receives the relative location of terminal device 110-1, the terminal device 110-1 may combine the relation location of terminal device 110-1 and the location determined based on the last reference signal. For example, for observed time difference of arrival (OTDOA), the location related measurement information may comprise the RSTD which is a combination of the last measured RSTD before AI based positioning and Δ_{RSTD}, where Δ_{RSTD} is timing difference transformed from the output of the AI/ML based model. Alternatively or in addition, for DL angle of departure (DL-AOD), the location related measurement information may comprise the RSRP which is a combination of the last measured RSRP before AI based positioning and Δ_{RSRP}, where Δ_{RSRP} is the RSRP value transformed from the output of the AI/ML based model. In some other embodiments, for UE Rx-TX time difference, the location related measurement information may comprise the RTT which is a combination of the last measured RTT before AI based positioning and Δ_{RTT}, where Δ_{RTT} is timing difference transformed from the output of the AI/ML based model.

According to embodiments described with reference to FIG. 4, the AI/ML based positioning model for DL measurement can be implemented at the network device. In this way, the position of the terminal device can be estimated more accurately. Moreover, it avoids extra power consumption at the terminal device.

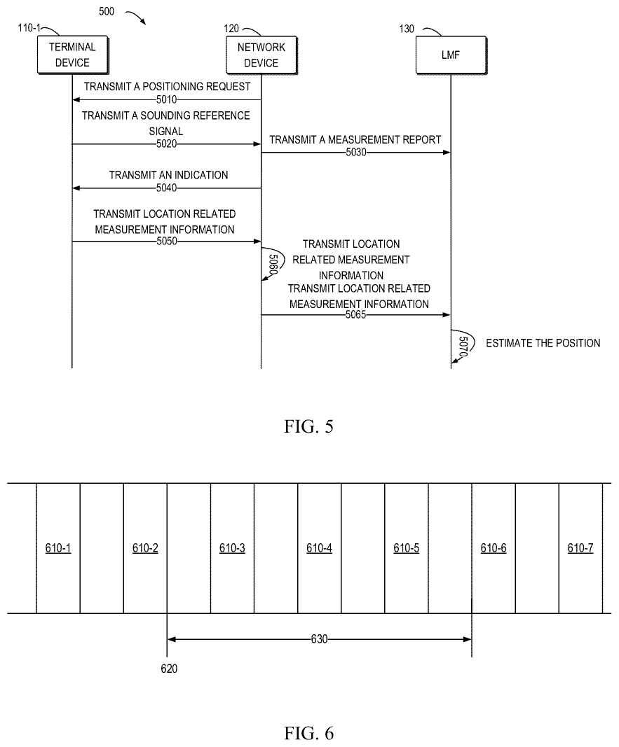

Embodiments of the present disclosure where the AI/ML based processing model is implemented at the network device will be described in detail below. Reference is first made to FIG. 5, which shows a signaling chart illustrating process 500 between the terminal device and the network device according to some example embodiments of the present disclosure. Only for the purpose of discussion, the process 500 will be described with reference to FIG. 1. The process 500 may involve the terminal device 110-1and the network device 120 in FIG. 1.

The network device 120 may transmit a configuration of SRS to the terminal device 110-1. In some embodiments, the configuration of SRS can be received via RRC signaling. In some embodiments, the configuration of SRS can comprise a number of physical resource blocks including transmission periodicity which are allocated for the SRS. Alternatively or in addition, the configuration of SRS can comprise a bandwidth parameter of SRS. In some embodiments, the configuration of SRS may indicate one or more SRS resources. Alternatively or in addition, the configuration of SRS may indicate one or more SRS resource sets. The network device 120 may transmit 5010 a positioning request for uplink positioning to the terminal device 110-1.

The terminal device 110-1 may transmit 5020 a set of SRSs to the network device 120 based on the configuration of SRS. The network device 120 may perform a measurement on the set of SRSs. For example, the measurement may be an UL RSTD, measurement. Alternatively or in addition, the measurement may also be an UL RSRP measurement. In some other embodiments, the measurement may be a Rx-Tx time difference measurement. The measurement may also be an UL AOA.

The network device 120 may transmit 5030 a measurement report to the core network device 130. For example, the measurement report may indicate the measured UL RSTD. Alternatively or in addition, the measurement report may indicate the measured UL RSRP. In some other embodiments, the measurement report may indicate the measured UL Rx-Tx time difference. In some embodiments, the measurement report may indicate the measured UL AOA.

In some embodiments, the terminal device 110-1 may determine whether a condition for triggering the AI/ML based positioning model is fulfilled. Alternatively, the network device 120 may determine whether a condition for triggering the AI/ML based positioning model is fulfilled. In some embodiments, the condition for triggering the AI/ML based positioning model may be that the line of sight (LOS) path does not exist due to the movement of the terminal device 110-1. Alternatively, the condition for triggering the AI/ML based positioning model may be that the LOS path does not exist due to changes of propagation environment. In some other embodiments, the condition for triggering the AI/ML based positioning model may be an unexpected synchronization error between the terminal device 110-1 and the network device 120 or between network devices. In another embodiment, the condition for triggering the AI/ML based positioning model may be that the reference position is inaccurate due to the movement of the network device 120. In some embodiments, the condition for triggering the AI/ML based positioning model may be a poor DL hearability from the neighbor cell to the terminal device 110-1. For example, if a link quality between a neighbor cell and the terminal device 110-1 is below a threshold, the AI/ML based positioning model may be triggered. Alternatively or in addition, the condition for triggering the AI/ML based positioning model may be reduction of overhead of reference signal. It should be noted that the condition for triggering the AI/ML based positioning model may comprise any other conditions which are not described.

In some embodiments, if the AI/ML based positioning model is triggered by the network device 120, the network device 120 may inform the terminal device 110-1 to start the AI/ML based measurement. For example, the network device 120 may transmit 5040 an indication for starting the AI/ML based positioning. In some embodiments, this indication can be transmitted in downlink control information. Alternatively, this indication can be transmitted in a medium access control (MAC) control element (CE). In example embodiments, the terminal device 110-1 may feedback to the network device 120 that the AI based positioning is not performed for some reasons, for example, UE power saving.

Alternatively, if the AI/ML based positioning model is triggered by the terminal device 110-1, the terminal device 110-1 may inform the network device 120 to mute the PRS resources during the AI/ML based positioning. Optionally, the network device 120 can inform the terminal device 110-1that AI based positioning is not performed for some reasons.

In some embodiments, if the AI/ML based positioning model is triggered, the network device 120 may cause the transmission of the PRS to be skipped. In other words, the network device 120 may mute resources for the PRS transmission. For example, as shown in FIG. 6, the PRSs can be transmitted on resources 610-1, 610-2, 610-3, 610-4, 610-5, 610-6 and 610-7. The AI/ML based positioning model may be triggered at the time instance 620. The AI/ML based positioning model may be running within the duration 630. In this case, the resources 610-3, 610-4 and 610-5 which are within the duration 630 can be muted. In other words, the network device 120 may not transmit PRSs within the duration 630. After the AI/ML based positioning model stops, the network device 120 may start to transmit PRSs.

Alternatively, if the AI/ML based positioning model is triggered, the terminal device 110-1 may cause the transmission of the SRS to be skipped. In other words, the terminal device 110-1 may mute resources for the SRS transmission.

In some embodiments, after receiving an indication of starting the AI/ML based positioning model, the terminal device 110-1 may not monitor the PRS on the occasions based on the configuration. The terminal device 110-1 may also transmit 5050 location related information to the network device 120. For example, the location related information may indicate a moving speed of the terminal device 110-1. Alternatively or in addition, the location related information may indicate a moving direction of the terminal device 110-1. The location related information may be transmitted on PUSCH.

If the AI/ML based positioning model is triggered, the network device 120 may determine 5060 location related measurement information of the terminal device 110-1 based on the AI/ML based positioning model. In some embodiments, the network device 120 may start the AI/ML based location estimation based on a historical location of the terminal device 110-1. Alternatively or in addition, the AI/ML based location estimation may be started based on a moving speed of the terminal device 110-1 and/or a moving direction of the terminal device 110-1 or the user preference profile, for example, user habits. It should be noted that the network device 120 may start the location estimation of the terminal device 110-1 using the positioning mode based on any proper factors.

In some embodiments, an input of the AI/ML based positioning model may comprise a set of previous RSTD measurements. Alternatively or in addition, the input of the AI/ML based positioning model may comprise a set of historical RSRP measurements. In some other embodiments, the input of the AI/ML based positioning model may comprise a set of RTT measurements. The input of the AI/ML based positioning model may also comprise a set of historical location coordinates of the terminal device 110-1. For example, the location coordinates may be obtained from a global positioning system.

In some embodiments, an output of the AI/ML based positioning model may comprise relative location information of the terminal device 110-1 with respect to a location determined based on the last reference signal. For example, this reference signal may be a PRS or a sounding reference signal. In some embodiments, the relative location information of the terminal device 110-1 may comprise a location coordinate of the terminal device 110-1 with respect to the last position based on the last reference signal. Alternatively, the relative location information of the terminal device 110-1 may comprise a RSTD with respect to the last reference signal. In other embodiments, the relative location of the terminal device 110-1 may comprise a RSRP with respect to the last reference signal. The relative location of the terminal device 110-1 may comprise a RTT with respect to the last reference signal.

Alternatively or in addition, the output of the AI/ML based positioning model may comprise absolute location information of the terminal device 110-1. In some embodiments, the absolute location information of the terminal device 110-1 may comprise a location coordinate of the terminal device 110-1. Alternatively, the absolute location of the terminal device 110-1 may comprise a RSTD. In other embodiments, the absolute location of the terminal device 110-1 may comprise a RSRP. The absolute location of the terminal device 110-1 may comprise a RTT.

The network device 120 may transmit 5965 the location related measurement information to the core network device 130. The core network device 130 may estimate 5070 the position of the terminal device 110-1 based on the location related measurement information.

In some embodiments, the location related measurement information may comprise the original output of the AI/ML based positioning model. For example, if the output of the AI/ML based positioning model is the absolute location of the terminal device 110-1, the location related measurement information may comprise the absolute location of the terminal device 110-1.

In some other embodiments, the location related measurement information may comprise a combination of the relation location of terminal device 110-1 and the location determined based on the last reference signal. For example, for uplink time difference of arrival (UTDOA), the location related measurement information may comprise the RTOA which is a combination of the last measured RTOA before AI based positioning and Δ_{RTOA}, where Δ_{RTOA} is timing difference transformed from the output of the AI/ML based model.

Alternatively or in addition, for UL AOA, the location related measurement information may comprise the RSRP which is a combination of the last measured RSRP before AI based positioning and Δ_{RSRP}, where Δ_{RSRP} is the RSRP value transformed from the output of the AI/ML based model. The location related measurement information may comprise the AOA which is a combination of the last measured AOA before AI based positioning and Δ_{AOA}, where Δ_{AOA} is the AOA value transformed from the output of the AI/ML based model. In some other embodiments, for gNB Rx-TX time difference, the location related measurement information may comprise the RTT which is a combination of the last measured RTT before AI based positioning and Δ_{RTT}, where Δ_{RTT} is timing difference transformed from the output of the AI/ML based model.

According to embodiments described with reference to FIG. 5, the AI/ML based positioning model for UL measurement can be implemented at the network device. In this way, the position of the terminal device can be estimated more accurately. Moreover, it avoids extra power consumption at the terminal device.

It should be noted that embodiments described with reference to FIGS. 2-5 can be implemented separately or together.

FIG. 7 shows a flowchart of an example method 700 in accordance with an embodiment of the present disclosure. The method 700 can be implemented at any suitable devices. Only for the purpose of illustrations, the method 700 can be implemented at a terminal device 110-1 as shown in FIG. 1.

At block 710, the terminal device 110-1 receives a configuration of an artificial intelligence/machine learning (AI/ML) based positioning model from the network device 120. The configuration of the AI/ML based positioning model comprising a set of parameters for the AI/ML based positioning model.

In some embodiments, the set of parameters for the AI/ML based positioning model comprises at least one of: an offset between a slot for an indication of triggering the AI/ML based positioning model and a start slot for the AI/ML based positioning model, or a duration parameter for the AI/ML based positioning model. For example, the duration parameter comprises one of: a bitmap parameter which is set to a predetermined value, an on-duration timer of the AI/ML based positioning model, or a parameter for disabling the NR-DL-PRS-PositioningFrequencyLayer or NR-DL-PRS-ResourceSet.

In some embodiments, the terminal device 110-1 may receive, from the network device 120, an indication for starting the AI/ML based positioning model. The indication may be in downlink control information or in a medium access control control element.

Alternatively or in addition, the terminal device 110-1 may transmit, to the network device 120, an indication for triggering the AI based positioning and requesting to mute a positioning reference signal resource within a duration of the AI/ML based positioning model. In this case, the terminal device 110-1 may also cause a reception of positioning reference signal to be skipped.

At block 720, if the AI/ML based positioning model is triggered, the terminal device 110-1 determines location related measurement information of the terminal device based on the AI/ML based positioning model.

In some embodiments, an input of the AI/ML based positioning model may comprise at least one of: a set of historical reference signal time difference (RSTD) measurements, a set of historical reference signal received power (RSRP) measurements, a set of historical round trip time (RTT) measurements, or a set of historical location coordinates of the terminal device.

Alternatively or in addition, an output of the AI/ML based positioning model may comprise at least one of: a relative location of the terminal device with respect to a location determined based on a reference signal; or an absolute location of the terminal device. In some embodiments, if the output of the AI/ML based positioning model comprises the relative location information of the terminal device, the location related measurement information may comprise a combination of the relative location measurement and the location information determined based on the last reference signal.

In some embodiments, the terminal device 110-1 may transmit a sounding reference signal to the network device 120. In this case, if the AI/ML based positioning model is started, the terminal device 110-1 may not transmit the sounding reference signal. In some embodiments, the terminal device 110-1 may transmit the location related measurement information to the network device 120.

At block 730, the terminal device 110-1 transmits the location related measurement information. In some embodiments, the location related measurement information comprises at least one of: a relative location of the terminal device with respect to a location determined based on a last reference signal, an absolute location of the terminal device, an as-the-crow-flies distance with respect to a last measurement slot of the last reference signal, an azimuth angle with respect to the last measurement slot, an elevation angle with respect to the last measurement slot, an uplink relative time of arrival (ROTA), an uplink angle of arrival (AOA), an uplink RSRP, or gNB round trip time.

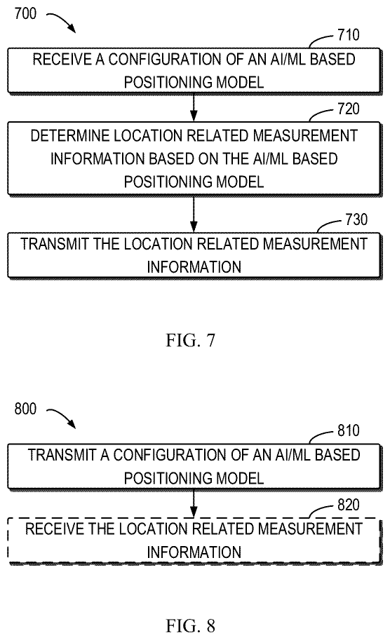

FIG. 8 shows a flowchart of an example method 800 in accordance with an embodiment of the present disclosure. The method 800 can be implemented at any suitable devices. Only for the purpose of illustrations, the method 800 can be implemented at a network device 120 as shown in FIG. 1.

At block 810, the network device 120 transmits a configuration of an artificial intelligence/machine learning (AI/ML) based positioning model to the terminal device 110-1. The configuration of the AI/ML based positioning model comprising a set of parameters for the AI/ML based positioning model.

In some embodiments, the network device 120 may transmit, to the terminal device 110-1, an indication for starting the AI/ML based positioning model. In some embodiments, the indication may be in downlink control information. Alternatively, the indication may be in a medium access control control element.

In some embodiments, the network device 120 may receive, from the terminal device 110-1, an indication for starting the AI based positioning and requesting to mute a positioning reference signal resource within a duration of the AI/ML based positioning model. In this case, the network device 120 may cause a transmission of positioning reference signal to be skipped.

In some embodiments, at block 820, the network device 120 may receive location related measurement information of the terminal device from the terminal device 110-1. The location related measurement information may be determined based on the AI/ML based positioning model. In this case, the network device 120 may also transmit the location related measurement information to a core network device.

In some embodiments, the location related measurement information may comprise at least one of: a relative location of the terminal device with respect to a location determined based on a last reference signal, an absolute location of the terminal device, an as-the-crow-flies distance with respect to a last measurement slot of the last reference signal, an azimuth angle with respect to the last measurement slot, an elevation angle with respect to the last measurement slot, an uplink relative time of arrival (ROTA), an uplink angle of arrival (AOA), an uplink RSRP, or a gNB round trip time.

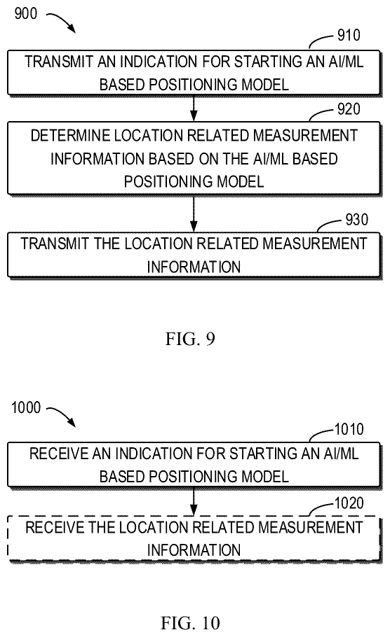

FIG. 9 shows a flowchart of an example method 900 in accordance with an embodiment of the present disclosure. The method 900 can be implemented at any suitable devices. Only for the purpose of illustrations, the method 900 can be implemented at a network device 120 as shown in FIG. 1.

At block 910, the network device 120 transmits, to the terminal device 110-1, an indication of start an artificial intelligence/machine learning (AI/ML) based positioning model. In some embodiments, the network device 120 may transmit a configuration of the AI/ML based positioning model. For example, the configuration of the AI/ML based positioning model comprises a set of parameters for the AI/ML based positioning model. and

In some embodiments, the set of parameters for the AI/ML based positioning model comprises at least one of: an offset between a slot for an indication of triggering the AI/ML based positioning model and a start slot for the AI/ML based positioning model, or a duration parameter for the AI/ML based positioning model. For example, the duration parameter comprises one of: a bitmap parameter which is set to a predetermined value, an on-duration timer of the AI/ML based positioning model, or a parameter for disabling the NR-DL-PRS-PositioningFrequencyLayer or NR-DL-PRS-ResourceSet.

In some embodiments, the terminal device 110-1 may receive, from the network device 120, an indication for starting the AI/ML based positioning model. The indication may be in downlink control information or in a medium access control control element.

Alternatively or in addition, the terminal device 110-1 may transmit, to the network device 120, an indication for triggering the AI based positioning and requesting to mute a positioning reference signal resource within a duration of the AI/ML based positioning model. In this case, the terminal device 110-1 may also cause a reception of positioning reference signal to be skipped.

At block 920, if the AI/ML based positioning model is triggered, the network device 120 determines location related measurement information of the terminal device based on the AI/ML based positioning model.

In some embodiments, an input of the AI/ML based positioning model may comprise at least one of: a set of historical reference signal time difference (RSTD) measurements, a set of historical reference signal received power (RSRP) measurements, a set of historical round trip time (RTT) measurements, or a set of historical location coordinates of the terminal device.

Alternatively or in addition, an output of the AI/ML based positioning model may comprise at least one of: a relative location of the terminal device with respect to a location determined based on a reference signal; or an absolute location of the terminal device. In some embodiments, if the output of the AI/ML based positioning model comprises the relative location information of the terminal device, the location related measurement information may comprise a combination of the relative location measurement and the location information determined based on the last reference signal. In some embodiments, if the AI/ML based positioning model is triggered, the network device 120 may case a transmission of positioning reference signal to be skipped.

At block 930, the network device 120 transmits the location related measurement information. In some embodiments, the location related measurement information may be transmitted to the terminal device 110-1. Alternatively, the location related measurement information may be transmitted to the core network device. In this case, the location related measurement information comprises at least one of: an uplink relative time of arrival (ROTA), an uplink angle of arrival (AOA), an uplink RSRP, or a receiving-transmitting time difference.

In some embodiments, the network device 120 may receive at least one of the followings from the terminal device 110-1: a moving speed of the terminal device, or a moving direction of the terminal device.

FIG. 10 shows a flowchart of an example method 1000 in accordance with an embodiment of the present disclosure. The method 1000 can be implemented at any suitable devices. Only for the purpose of illustrations, the method 1000 can be implemented at a terminal device 110-1 as shown in FIG. 1.

At block 1010, the terminal device 110-1 receives an indication of start an artificial intelligence/machine learning (AI/ML) based positioning model from the network device 120. In some embodiment, the terminal device 110-1 may also receive a configuration of an artificial intelligence/machine learning (AI/ML) based positioning model and The configuration of the AI/ML based positioning model comprising a set of parameters for the AI/ML based positioning model.

In some embodiments, the set of parameters for the AI/ML based positioning model comprises at least one of: an offset between a slot for an indication of triggering the AI/ML based positioning model and a start slot for the AI/ML based positioning model, or a duration parameter for the AI/ML based positioning model. For example, the duration parameter comprises one of: a bitmap parameter which is set to a predetermined value, an on-duration timer of the AI/ML based positioning model, or a parameter for disabling the NR-DL-PRS-PositioningFrequencyLayer or NR-DL-PRS-ResourceSet.

In some embodiments, at block 1020, the terminal device 110-1 may receive, from the network device 120, location related measurement information of the terminal device which is determined based on the AI/ML based positioning model. The terminal device 110-1 may transmit, to a core network device, the location related measurement information of the terminal device. In some embodiments, the location related measurement information may comprise an absolute location of the terminal device. Alternatively, the location related measurement information may comprise a relative location of the terminal device and a location determined based on the last reference signal.

In some embodiments, if the AI/ML based positioning model is triggered, the terminal device 110-1 may cause a transmission of sounding reference signal to be skipped.

In some embodiments, the terminal device 110-1 may transmit at least one of the followings to the network device 120: a moving speed of the terminal device, or a moving direction of the terminal device.

In some embodiments, a terminal device comprises circuitry configured to perform: receiving, from a network device, a configuration of an artificial intelligence/machine learning (AI/ML) based positioning model and an indication of starting the AI/ML based positioning model, the configuration of the AI/ML based positioning model comprising a set of parameters for the AI/ML based positioning model; in accordance with a determination that the AI/ML based positioning model is triggered, determining location related measurement information of the terminal device based on the AI/ML based positioning model; and transmitting the location related measurement information.

In some embodiments, the set of parameters for the AI/ML based positioning model comprises at least one of: an offset between a slot for an indication of triggering the AI/ML based positioning model and a start slot for the AI/ML based positioning model, or a duration parameter for the AI/ML based positioning model.

In some embodiments, the duration parameter comprises one of: a bitmap parameter which is set to a predetermined value, an on-duration timer of the AI/ML based positioning model, or a parameter for disabling the NR-DL-PRS-PositioningFrequencyLayer or NR-DL-PRS-ResourceSet.

In some embodiments, the indication for starting the AI/ML based positioning model is received in downlink control information or in a medium access control control element.

In some embodiments, the terminal device comprises circuitry configured to perform: transmitting, to the network device, an indication for triggering the AI based positioning and requesting to mute a positioning reference signal resource within a duration of the AI/ML based positioning model; and causing a reception of positioning reference signal to be skipped.

In some embodiments, an input of the AI/ML based positioning model comprises at least one of: a set of historical reference signal time difference (RSTD) measurements, a set of historical reference signal received power (RSRP) measurements, a set of historical round trip time (RTT) measurements, or a set of historical location coordinates of the terminal device.

In some embodiments, an output of the AI/ML based positioning model comprises at least one of: a relative location of the terminal device with respect to a location determined based on a last reference signal; or an absolute location of the terminal device.

In some embodiments, if the output of the AI/ML based positioning model comprises the relative location of the terminal device, the location related measurement information comprises a combination of the relative location and the location determined based on the last reference signal.

In some embodiments, the terminal device comprises circuitry configured to perform: transmitting, to the network device, a sounding reference signal; in accordance with a determination that the AI/ML based positioning model is started, causing a transmission of sounding reference signal to be skipped; and transmitting the location related measurement information to the network device.

In some embodiments, the location related measurement information comprises at least one of: a relative location of the terminal device with respect to a location determined based on a last reference signal, an absolute location of the terminal device, an as-the-crow-flies distance with respect to a last measurement slot of the last reference signal, an azimuth angle with respect to the last measurement slot, an elevation angle with respect to the last measurement slot, an uplink relative time of arrival (ROTA), an uplink angle of arrival (AOA), an uplink RSRP, or gNB round trip time.

In some embodiments, a network device comprises circuitry configured to perform: transmitting, at a network device and to a terminal device, a configuration of an artificial intelligence/machine learning (AI/ML) based positioning model and an indication of start the AI/ML based positioning model, the configuration of the AI/ML based positioning model comprising a set of parameters for the AI/ML based positioning model.

In some embodiments, the network device comprises circuitry configured to perform: transmitting, to the terminal device, an indication for starting the AI/ML based positioning model, wherein the indication is in downlink control information or in a medium access control control element.

In some embodiments, the network device comprises circuitry configured to perform: receiving, from the terminal device, an indication for starting the AI based positioning and requesting to mute a positioning reference signal resource within a duration of the AI/ML based positioning model; and causing a transmission of positioning reference signal to be skipped.

In some embodiments, the network device comprises circuitry configured to perform: receiving location related measurement information of the terminal device from the terminal device, the location related measurement information being determined based on the AI/ML based positioning model; and transmitting the location related measurement information to a core network device.

In some embodiments, the location related measurement information comprises at least one of: a relative location of the terminal device with respect to a location determined based on a last reference signal, an absolute location of the terminal device, an as-the-crow-flies distance with respect to a last measurement slot of the last reference signal, an azimuth angle with respect to the last measurement slot, an elevation angle with respect to the last measurement slot, an uplink relative time of arrival (ROTA), an uplink angle of arrival (AOA), an uplink RSRP, or a gNB round trip time.

In some embodiments, a network device comprises circuitry configured to perform: transmitting, at a network device and to a terminal device, an indication of starting an artificial intelligence/machine learning (AI/ML) based positioning model; in accordance with a determination that the AI/ML based positioning model is triggered, determining location related measurement information of the terminal device based on the AI/ML based positioning model; and transmitting the location related measurement information.

In some embodiments, the network device comprises circuitry configured to perform: transmitting, to the terminal device, a configuration of the AI/ML based positioning model, wherein the configuration of the AI/ML based positioning model comprises a set of parameters for the AI/ML based positioning model.

In some embodiments, the set of parameters for the AI/ML based positioning model comprises at least one of: an offset between a slot for an indication of triggering the AI/ML based positioning model and a start slot for the AI/ML based positioning model, or a duration parameter for the AI/ML based positioning model.

In some embodiments, the duration parameter comprises one of: a bitmap parameter which is set to a predetermined value, an on-duration timer of the AI/ML based positioning model, or a parameter for disabling a NR-DL-PRS-PositioningFrequencyLayer or NR-DL-PRS-ResourceSet.

In some embodiments, an input of the AI/ML based positioning model comprises at least one of: a set of historical reference signal time difference (RSTD) measurements, a set of historical reference signal received power (RSRP) measurements, a set of historical round trip time (RTT) measurements, or a set of historical location coordinates of the terminal device.

In some embodiments, an output of the AI/ML based positioning model comprises at least one of: a relative location of the terminal device with respect to a location determined based on a last reference signal; or an absolute location of the terminal device.

In some embodiments, if the output of the AI/ML based positioning model comprises the relative location of the terminal device, the location related measurement information comprises a combination of the relative location and the location determined based on the last reference signal.

In some embodiments, the network device comprises circuitry configured to perform: in accordance with a determination that the AI/ML based positioning model is triggered, causing a transmission of positioning reference signal to be skipped.

In some embodiments, the network device comprises circuitry configured to perform transmitting the location related measurement information by: transmitting the location related measurement information to the terminal device.

In some embodiments, the network device comprises circuitry configured to perform transmitting the location related measurement information by: transmitting the location related measurement information to the core network device.

In some embodiments, the location related measurement information comprises at least one of: an uplink relative time of arrival (ROTA), an uplink angle of arrival (AOA), an uplink RSRP, or a receiving-transmitting time difference.

In some embodiments, the network device comprises circuitry configured to perform: receiving at least one of the followings from the terminal device: a moving speed of the terminal device, or a moving direction of the terminal device.

In some embodiments, a terminal device comprises circuitry configured to perform receiving, from a network device, an indication of starting an artificial intelligence/machine learning (AI/ML) based positioning model.

In some embodiments, the terminal device comprises circuitry configured to perform receiving, from the network device, a configuration of the AI/ML based positioning model, wherein the configuration of the AI/ML based positioning model comprises a set of parameters for the AI/ML based positioning model.

In some embodiments, the set of parameters for the AI/ML based positioning model comprises at least one of: an offset between a slot for an indication of triggering the AI/ML based positioning model and a start slot for the AI/ML based positioning model, or a duration parameter for the AI/ML based positioning model.

In some embodiments, the duration parameter comprises one of: a bitmap parameter which is set to a predetermined value, an on-duration timer of the AI/ML based positioning model, or a parameter for disabling a NR-DL-PRS-PositioningFrequencyLayer or NR-DL-PRS-ResourceSet.

In some embodiments, the terminal device comprises circuitry configured to perform receiving, from the network device, location related measurement information of the terminal device which is determined based on the AI/ML based positioning model; and transmitting, to a core network device, the location related measurement information of the terminal device.

In some embodiments, the location related measurement information comprises an absolute location of the terminal device, or the location related measurement information comprises a relative location of the terminal device and a location determined based on the last reference signal.

In some embodiments, the terminal device comprises circuitry configured to perform in accordance with a determination that the AI/ML based positioning model is triggered, causing a transmission of sounding reference signal to be skipped.

In some embodiments, the terminal device comprises circuitry configured to perform transmitting at least one of the followings to the network device: a moving speed of the terminal device, or a moving direction of the terminal device.

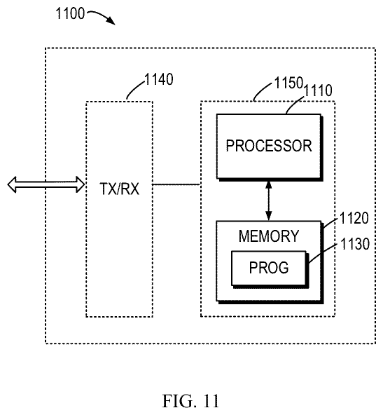

FIG. 11 is a simplified block diagram of a device 1100 that is suitable for implementing embodiments of the present disclosure. The device 1100 can be considered as a further example implementation of the terminal device 110-1 or the network device 120 as shown in FIG. 1. Accordingly, the device 1100 can be implemented at or as at least a part of the terminal device 110-1 or the network device 120.

As shown, the device 1100 includes a processor 1110, a memory 1120 coupled to the processor 1110, a suitable transmitter (TX) and receiver (RX) 1140 coupled to the processor 1110, and a communication interface coupled to the TX/RX 1140. The memory 1120 stores at least a part of a program 1130. The TX/RX 1140 is for bidirectional communications. The TX/RX 1140 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1130 is assumed to include program instructions that, when executed by the associated processor 1110, enable the device 1100 to operate in accordance with the embodiments of the present disclosure, as discussed herein with reference to FIGS. 2 to 10. The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1120 may form processing means 1150 adapted to implement various embodiments of the present disclosure.

The memory 1120 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1120 is shown in the device 1200, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 to 10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHZ-7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The network device may have the function of network energy saving, Self-Organising Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

1. A communication method, comprising:
receiving, at a terminal device and from a network device, a configuration of an artificial intelligence/machine learning (AI/ML) based positioning model and an indication of starting the AI/ML based positioning model, the configuration of the AI/ML based positioning model comprising a set of parameters for the AI/ML based positioning model;
in accordance with a determination that the AI/ML based positioning model is triggered, determining location related measurement information of the terminal device based on the AI/ML based positioning model; and
transmitting the location related measurement information.

2. The method of claim 1, wherein the set of parameters for the AI/ML based positioning model comprises at least one of:
an offset between a slot for an indication of triggering the AI/ML based positioning model and a start slot for the AI/ML based positioning model, or
a duration parameter for the AI/ML based positioning model.

3. The method of claim 2, wherein the duration parameter comprises one of:
a bitmap parameter which is set to a predetermined value,
an on-duration timer of the AI/ML based positioning model, or
a parameter for disabling the NR-DL-PRS-PositioningFrequencyLayer or NR-DL-PRS-ResourceSet.

4. The method of claim 1, wherein the indication for starting the AI/ML based positioning model is received in downlink control information or in a medium access control control element.

5. The method of claim 1, further comprising:
transmitting, to the network device, an indication for triggering the AI based positioning and requesting to mute a positioning reference signal resource within a duration of the AI/ML based positioning model; and
causing a reception of positioning reference signal to be skipped.

6. The method of claim 1, wherein an input of the AI/ML based positioning model comprises at least one of:
a set of historical reference signal time difference (RSTD) measurements,
a set of historical reference signal received power (RSRP) measurements,
a set of historical round trip time (RTT) measurements, or
a set of historical location coordinates of the terminal device.

7. The method of claim 1, wherein an output of the AI/ML based positioning model comprises at least one of:
a relative location of the terminal device with respect to a location determined based on a last reference signal; or
an absolute location of the terminal device.

8. The method of claim 7, wherein if the output of the AI/ML based positioning model comprises the relative location of the terminal device, the location related measurement information comprises a combination of the relative location and the location determined based on the last reference signal.

9. The method of claim 1, further comprising:
transmitting, to the network device, a sounding reference signal;
in accordance with a determination that the AI/ML based positioning model is started, causing a transmission of sounding reference signal to be skipped; and
transmitting the location related measurement information to the network device.

10. The method of claim 9, wherein the location related measurement information comprises at least one of:
a relative location of the terminal device with respect to a location determined based on a last reference signal,
an absolute location of the terminal device,
an as-the-crow-flies distance with respect to a last measurement slot of the last reference signal,
an azimuth angle with respect to the last measurement slot,
an elevation angle with respect to the last measurement slot,
an uplink relative time of arrival (ROTA),
an uplink angle of arrival (AOA),
an uplink RSRP, or
gNB round trip time.

11. A communication method, comprising:
transmitting, at a network device and to a terminal device, a configuration of an artificial intelligence/machine learning (AI/ML) based positioning model and an indication of start the AI/ML based positioning model, the configuration of the AI/ML based positioning model comprising a set of parameters for the AI/ML based positioning model.

12. The method of claim 11, further comprising:
transmitting, to the terminal device, an indication for starting the AI/ML based positioning model, wherein the indication is in downlink control information or in a medium access control control element.

13. The method of claim 11, further comprising:
receiving, from the terminal device, an indication for starting the AI based positioning and requesting to mute a positioning reference signal resource within a duration of the AI/ML based positioning model; and
causing a transmission of positioning reference signal to be skipped.

14. The method of claim 11, further comprising:
receiving location related measurement information of the terminal device from the terminal device, the location related measurement information being determined based on the AI/ML based positioning model; and
transmitting the location related measurement information to a core network device.

15. The method of claim 14, wherein the location related measurement information comprises at least one of:
a relative location of the terminal device with respect to a location determined based on a last reference signal,
an absolute location of the terminal device,
an as-the-crow-flies distance with respect to a last measurement slot of the last reference signal,
an azimuth angle with respect to the last measurement slot,
an elevation angle with respect to the last measurement slot,
an uplink relative time of arrival (ROTA),
an uplink angle of arrival (AOA),
an uplink RSRP, or
a gNB round trip time.

16-35. (canceled)

36. A terminal device comprising:
a processor; and
a memory coupled to the processor and storing instructions thereon, the instructions, when executed by the processor, causing the terminal device to:
receive, from a network device, a configuration of an artificial intelligence/machine learning (AI/ML) based positioning model and an indication of starting the AI/ML based positioning model, the configuration of the AI/ML based positioning model comprising a set of parameters for the AI/ML based positioning model;
in accordance with a determination that the AI/ML based positioning model is triggered, determine location related measurement information of the terminal device based on the AI/ML based positioning model; and
transmit the location related measurement information.

37-38. (canceled)

39. The terminal device of claim 36, wherein the set of parameters for the AI/ML based positioning model comprises at least one of:
an offset between a slot for an indication of triggering the AI/ML based positioning model and a start slot for the AI/ML based positioning model, or
a duration parameter for the AI/ML based positioning model.

40. The terminal device of claim 39, wherein the duration parameter comprises one of:
a bitmap parameter which is set to a predetermined value,
an on-duration timer of the AI/ML based positioning model, or
a parameter for disabling the NR-DL-PRS-PositioningFrequencyLayer or NR-DL-PRS-ResourceSet.

41. The terminal device of claim 36, wherein the indication for starting the AI/ML based positioning model is received in downlink control information or in a medium access control control element.

42. The terminal device of claim 36, wherein the terminal device is further caused to:
transmit, to the network device, an indication for triggering the AI based positioning and requesting to mute a positioning reference signal resource within a duration of the AI/ML based positioning model; and
cause a reception of positioning reference signal to be skipped.
